(19) United States
(12) Patent Application Publication
(10) Pub. No.: US 2009/0119974 A1
(43) Pub. Date: May 14, 2009

(54) Fishing Line Holder

(76) Inventor: Yvan Rieux, Hallandale, FL (US)

Correspondence Address: CHRISTOPHER J. VANDAM, P.A., 19600 NE 21 Ct., MIAMI, FL, 33179, US

(21) Appl. No.: 11/937,584

(22) Filed: Nov. 9, 2007

(51) Int. Cl. A01K 97/06

(52) U.S. Cl. 43/54.1; 43/57.2

(57) ABSTRACT

The disclosed device is an improved fishing line organizer that, among other features, provides a frame to wrap multiple and varying fishing lines and terminal tackle around for storage reducing tangling, preventing line kinks and maintaining each fishing line available for use. An embodiment of the device provides for construction of the device from a material (or materials) sufficiently buoyant to float when holding multiple fishing lines and terminal tackle.

### BACKGROUND OF THE INVENTION

1. Field of the Invention

The present invention relates to fishing, and more particularly, to an improved fishing line holder.

2. Description of the Related Art

Several designs for fishing line holders have been designed in the past. None of them, however, include a fishing line organizer that floats, prevents line kinks, works with modern terminal tackle and works with any length of line.

Applicant believes that the closest reference corresponds to U.S. Pat. No. 2,879,619 issued to Victor N. Peterson. However, it differs from the present device because, inter alia, the present device includes slots to catch a swivel (or other terminal tackle) and can float thereby reducing the possibility of losing the device in the water.

Other patents describing the closest subject matter provide for a number of more or less complicated features that fail to solve the problem in an efficient and economical way. None of these patents suggest the novel features of the present invention.

### SUMMARY OF THE INVENTION

The present device is essentially a fishing line holder comprising a frame taking the form of a substantially rectangular plate with a first edge, a second edge, a third edge, a fourth edge, a first face and a second face. Said frame being buoyant and having a series of ridges on said first edge with a corresponding number of ridges on said third edge. Said second and said fourth edges being flat. Between each adjacent ridge is a slot dimensioned to permit the passage of fishing line into the slot but not the passage of terminal tackle.

The frame may be constructed from natural cork, synthetic cork, a core of rigid plastic fixed between two layers of cork, a core of rigid material fixed between two layers of material penetrable by a fishing hook, other material penetrable by a fishing hook.

The fishing line holder may also have channels in said first face and said second face of said frame that are parallel to said second edge and extend from each slot on said first edge to the corresponding slot on said third edge.

The fishing line holder may also have a rounded edge inside each slot on said first and third edge sufficient to reduce bends, kinks or creases in a fishing line wrapped around said frame and into said slots.

It is one of the main objects of the present invention to provide a device that floats.

It is another object of this invention to provide a device that reduces any creases or kinks in fishing line.

It is still another object of the present invention to provide a device that neatly stores fishing lines of widely varying lengths and with a wide variety of terminal tackle

It is yet another object of this invention to provide such a device that is inexpensive to manufacture and maintain while retaining its effectiveness.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 represents a perspective view of the device holding a section of fishing line.

FIG. 2 shows a perspective view of a cross-section of the device showing in detail the characteristics of the slot.

FIG. 3 illustrates several examples of terminal tackle commonly in use today.

FIG. 4 shows a perspective view of an embodiment of the device.

### DETAILED DESCRIPTION OF THE PREFERRED EMBODIMENT

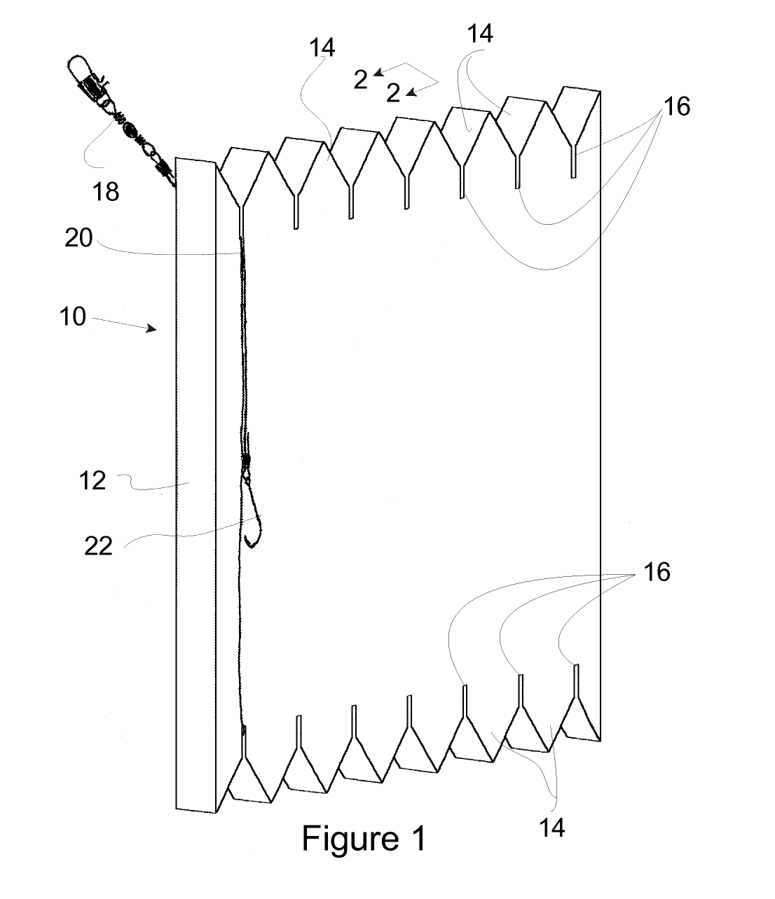

Referring now to the drawings, where the device is generally referred to in FIG. 1 with numeral 10, it can be observed that it basically includes a frame 12, ridges 14 and slots 16. Said frame 12 may take the form of a substantially rectangular plate having four edges, a first face and a second. Two of said edges of the frame 12 opposite each other have a series of ridges 14 separated by a series of slots 16. One slot 16 is positioned between each of said ridges 14 and transverses the thickness of the frame 12.

A usefulness of said ridges 14 is to prevent a fishing line from sliding along an edge of the frame and becoming entangled with other lines wrapped around the frame 12. Said ridges 14 may have a triangular profile as demonstrated in FIG. 1 or may alternatively have a rounded profile. The dimensions of the ridges 14 are such that when a fishing line is wrapped multiple times around the frame 12 and between two adjacent ridges 14 the fishing line does spill over between another pair of ridges 14.

Said slots 16 are positioned between each of said ridges 14. The slots 16 are dimensioned to permit fishing line to pass to the base of the slot 16 but narrow enough to prevent terminal tackle, such as a swivel, clip, crimped loop or other typical fishing line connector, from being able to pass through the slot 16. Multiple slots 16 are provided on each of two opposing edges. Each of the slots 16 is paired with a slot 16 on the opposing edge that work in cooperation to secure one or more fishing lines.

FIG. 1 shows an example of how the device could be used to secure a swivel 18, a line 20 and a hook 22. Generally, the line 20 near the swivel 18 is placed into said slot 16 and the line 20 is pulled so that the swivel 18 presses against the side of the slot 18 either against said first face or second face of the frame 12. The line 20 is wrapped around the frame 12 and then through the corresponding slot 18 on the opposing edge of the frame 12. The line 20 is repeatedly wrapped around the frame 12 and through the same two slots 16 until the length of the line 20 is exhausted and the hook 22 is then pierced into the side of the frame 12 under enough tension to prevent the line 20 from unwinding.

In a variation of the device said frame 12 is formed of a semi-rigid unitary piece of natural or artificial cork, foam, plastic or other material capable of maintaining the form of the device as described and pierce-able by the sharp point of a fishing hook and resistant to damage from repeated insertion and removal of fishing hooks. The material or materials the device is constructed from provides buoyancy sufficient to prevent the device from sinking even when wound with multiple fishing lines, hooks and other terminal tackle.

In another variation of the device the frame 12 is formed from a series of laminate layers. For example, a rigid layer sandwiched by pieces of natural or artificial cork, foam, plastic or other material pierce-able by the sharp point of a fishing hook and resistant to damage from repeated insertion and removal of fishing hooks.

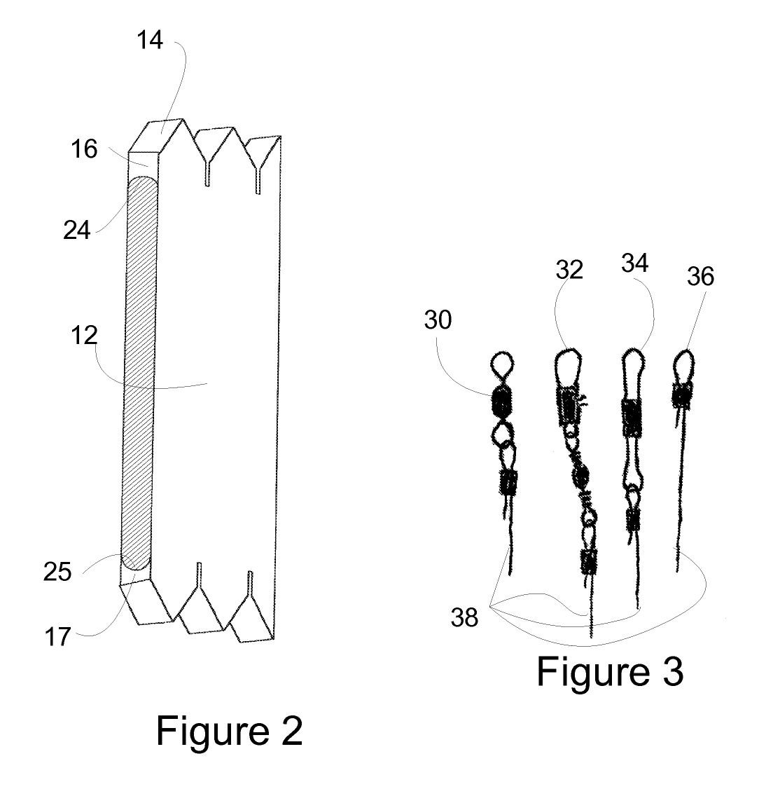

FIG. 2 shows a cross-section of a variation of the device comprising, inter alia, a frame 12, ridges 14, a slot 16, a slot 17, an edge 24 and an edge 25. The interior of slot 16 is shown in include an edge 24 with a rounded profile. A slot 17 is opposite slot 16 and corresponds to slot 16 and also has an edge 25 with a rounded profile. In typical use of the device fishing line is repeatedly wound around the frame 12 and in slot 16 and slot 17. The rounded profiles of the edge 24 and edge 25 aid in preventing a crease, kink or bend in a fishing line wrapped around the device. In one embodiment of the device all of the several slots have rounded edges similar to the edge 24 and edge 25.

FIG. 3 shows an example of several types of terminal tackle that are in common use today. Any of these and many other types of terminal tackle would be effective when used with the device. Commonly used and compatible with this device include, inter alia, a swivel 30, a clip 34, a swivel clip 32 and/or a crimped loop 36. A segment of fishing line 38 is connected to any of the shown terminal tackle. Said fishing line 38 is wound around the device in typical use of the device.

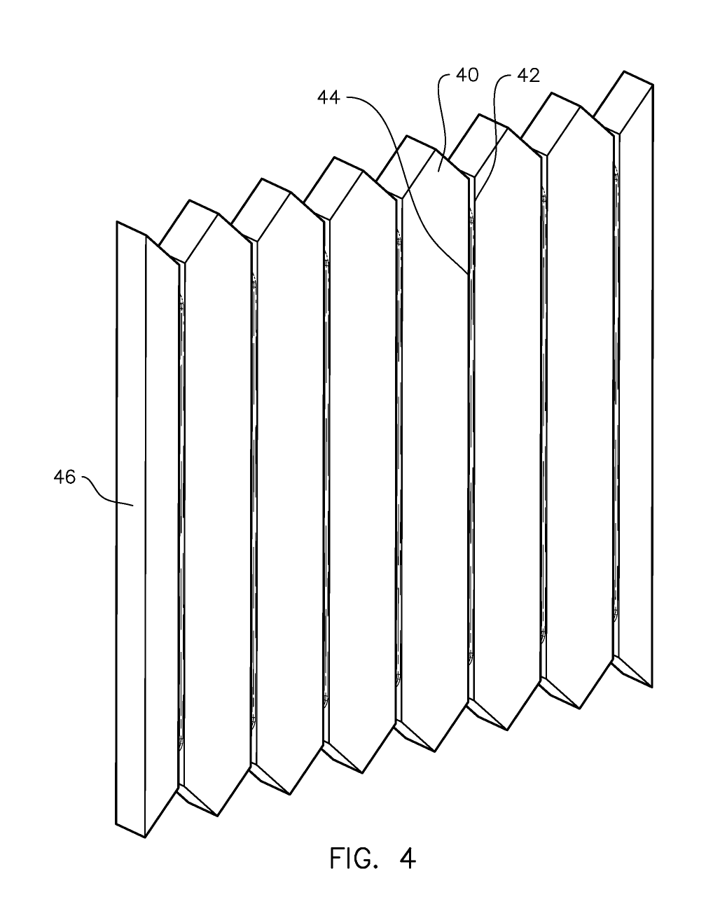

FIG. 4 shows an alternate embodiment of the device comprising, inter alia, a frame 46, ridges 40, slots 42 and channels 44. The device functions similar to any of the devices described herein and is further characterized in particular by said channel 44. Said channel 44 provides a recess that fishing line lays in when wound around said frame 46. When multiple fishing lines are wound around the frame 46 and each into adjacent slots 42 the channels 44 act to separate the fishing lines held in adjacent slots and channels and thereby aids in preventing tangling of the fishing lines.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A fishing line holder comprising:
A frame taking the form of a substantially rectangular plate with a first edge, a second edge, a third edge, a fourth edge, a first face and a second face; said frame being buoyant; said frame having a series of ridges on said first edge with a corresponding number of ridges on said third edge; said second and said fourth edges being flat; between each adjacent ridge is a slot dimensioned to permit the passage of fishing line into the slot but not the passage of terminal tackle.

2. A fishing line holder as in claim 1 further characterized in that said frame is constructed from natural or synthetic cork.

3. A fishing line holder as in claim 1 further characterized in that said frame is constructed of a core of rigid plastic fixed between two layers of cork.

4. A fishing line holder as in claim 1 further characterized in that said frame is constructed from a material penetrable by a fishing hook.

5. A fishing line holder as in claim 1 further characterized in that said frame is constructed of a core of rigid material fixed between two layers of material penetrable by a fishing hook.

6. A fishing line holder as in claim 1 further characterized by channels in said first face and said second face of said frame that are parallel to said second edge and extend from each slot on said first edge to the corresponding slot on said third edge.

7. A fishing line holder as in claim 1 further characterized in that inside each slot on said first and third edge is rounded sufficiently to reduce bends, kinks or creases in a fishing line wrapped around said frame and into said slots.
